(19) United States
(12) Patent Application Publication
(10) Pub. No.: US 2008/0286985 A1
(43) Pub. Date: Nov. 20, 2008

(54) Electronic Device with Multiple-Direction Rotation Connector

(75) Inventor: Shen Feng Huang, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP., Sijhih City (TW)

(21) Appl. No.: 12/117,936

(22) Filed: May 9, 2008

(30) Foreign Application Priority Data
May 10, 2007 (CN) 200720147425.0

(51) Int. Cl. H01R 41/00

(52) U.S. Cl. 439/6

(57) ABSTRACT

An electronic device with a multiple-direction rotation connector includes a main body and a pivoting structure. The main body has a bearing structure while the pivoting structure pivots on the bearing structure to rotate along the first and second axes. The pivoting structure has two convex ends, while the bearing structure has two opposite concaves adapted to receive the convex ends respectively. One of the concaves is formed with a protruding column that is adapted to slide within a groove formed on the pivoting structure. Thereby, the connector can be accommodated in the main body and rotates in multiple directions for the preferred operation.

This application claims priority to China Patent Application No. 200720147425.0 filed on May 10, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to an electronic device having a connector. In particular, this invention relates to an electronic device with a multiple-direction rotation connector.

2. Descriptions of the Related Art

Because portable drives have large capacities, small dimensions, high transmission rates, and a light-weight, they have become popular with consumers. The most important application of the portable drives is that they can be extensively used for personal computers to backup, copy and deliver digital files.

Furthermore, in addition to the aforesaid portable drives, other electronic devices, such as wireless network receivers or wireless mouse receivers, may use USB connectors disposed at the end of the body to electrically connect to electronic apparatuses (such as laptops, or desktop PCs). By using the USB connector, the user can plug the electronic device into the USB socket of the electronic apparatus to electrically connect the electronic device with the electronic apparatus.

Some of the conventional USB connectors are designed in a multiple-direction rotation function, so that the angle between the USB connector and the device body can be adjusted. Thereby, it is more convenient for users to plug the electronic device into an electronic apparatus. For example, Taiwan patent M274720, published on Sep. 1, 2005, has disclosed a rotatable wireless receiving and transmitting device; and Taiwan patent M278208, published on Oct. 11, 2005, has disclosed a multiple-direction rotation electronic device. Both publications disclose electronic devices that include a multiple-direction rotation connector.

However, to allow the USB connector to rotate in multiple directions, the conventional electronic devices need complex rotation elements or rotation units, which lead to increased manufacturing costs. Furthermore, because the dimensions of the conventional rotation elements or rotating units are large, the electronic devices are bulky, and therefore do not follow the trend of slimmer and lighter electronic devices.

### SUMMARY OF THE INVENTION

One objective of the present invention is to provide an electronic device with a multiple-direction rotation connector. Due to the simpler structure of the present invention, the manufacturing costs are not only reduced, but the electronic device can also become slimmer and lighter.

To achieve the objectives, the electronic device with a multiple-direction rotation connector includes a main body and a pivoting structure. The main body has a bearing structure. The connector is fixed onto the pivoting structure, which pivots on the bearing structure for rotating along a first axis or a second axis. The pivoting structure comprises two convex ends, while the bearing structure comprises two opposite concaves adapted to receive the convex end respectively. Thus, the pivoting structure is capable of rotating along the first axis when the convex ends rotate with respect to the concaves. One of the convex ends is formed with a groove. The bearing structure comprises a protruding column formed on one of the concaves. Thus, the pivoting structure is capable of rotating along the second axis when the protruding column slides within the groove.

The present invention discloses a structure including the simplified bearing structure and pivoting structure for reducing manufacturing costs. Furthermore, the dimension of the pivoting structure used in the present invention is smaller, so that meets the trend of slim dimension and light weight in the electronic device.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is an exploded view illustrating the electronic device of the present invention;

FIG. 2 is a perspective view illustrating the electronic device of the present invention;

FIG. 3 is a front elevational view illustrating the electronic device of the present invention;

FIG. 4 is a cross-sectional view along line 4-4 in FIG. 3;

FIG. 5 is a cross-sectional view along line 5-5 in FIG. 3;

FIG. 6 is a perspective view illustrating an operating status of the electronic device of the present invention; and

FIG. 7 is a perspective view illustrating another operating status of the electronic device of the present invention.

### DESCRIPTION OF THE PREFERRED EMBODIMENT

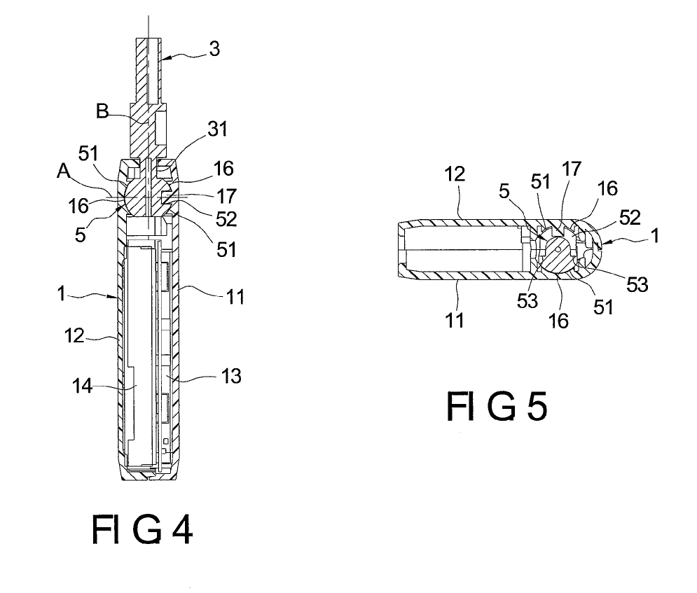

As shown in FIGS. 1 to 5, an electronic device with a multiple-direction rotation connector is illustrated. The electronic device can be a portable drive, a wireless network receiver, or a wireless mouse receiver. In this embodiment, the electronic device is illustrated as a portable drive. The electronic device includes a main body 1, a connector 3, and a pivoting structure 5 with a configuration of shaft or column. The main body 1 includes a first shell 11 and a second shell 12, which can be made of plastic or metal materials. The first shell 11 and the second shell 12 are substantially symmetrical, and can be assembled by screwing, buckling, or supersonic machining to form an interior therein. The interior of the main body 1 comprises a first receiving space 13 and a second receiving space 15. The first receiving space 13 is used to receive an electronic element 14. In this embodiment, the electronic element 14 is a storage device, such as a hard disk or a memory.

The second receiving space 15 is on one side of the interior for accommodating the connector 3 and the pivoting structure 5. As shown in the figures, an opening is formed on the two adjacent side walls to expose the second receiving space 15 so that the second receiving space 15 is capable of communicating with the outside of the main body 1. Thus, the connector 3 can pass through the opening for accommodation in the second receiving space 15.

The main body 1 comprises a bearing structure to receive the pivoting structure 5. As shown in FIG. 1, the bearing structure comprises two opposite concaves 16 that are formed on each of the two opposite inner walls of the first shell 11 and the second shell 12 of the main body 1. More specifically, each of the concaves 16 has a spherical surface formed on the base 20. Furthermore, two side partitions 21 are disposed adjacent to each of the concaves 16 for constraining the pivoting structure 5. The two side partitions 21 are located on two opposite sides with respect to the base 20.

Furthermore, a positioning plate 18 and a positioning block 19 are disposed in the second receiving space 15. More specifically, the positioning plate 18 is disposed on one side of the second receiving space 15 and adjacent to one of the concaves 16 of the bearing structure. The positioning block 19 is located on the other side of the second receiving space 15 and is disposed from the concaves 16 of the bearing structure. The positioning plate 18 can be flexible, while the positioning block 19 can be made of a flexible material, such as foam. The positioning plate 18 and the positioning block 19 are both utilized to position the connector 3.

In this embodiment, the connector 3 is a USB connector or an IEEE 1394 connector. The rear end of the connector 3 is electrically connected with the electronic element 14 via a conducting wire 7. The connector 3 further has a rod 31, which is disposed at an end portion of the connector 3, to be fixed onto the pivoting structure 5. In this case, the conducting wire 7 passes through the rod 31 to electrically connect with the electronic element 14.

The pivoting structure 5 can be made of plastic materials. The pivoting structure 5 is fastened on the rear end of the rod 31 of the connector 3, so that the pivoting structure 5 is fixed to the connector 3. Each of the ends of the shaft 5 is a convex end 51 corresponds to the concaves 16. Thus, the convex ends 51 are adapted to rotate on the concaves 16 of the bearing structure, respectively. In particular, each of the convex ends 51 comprises a spherical surface. The pivoting structure 5 further comprises a groove 52 formed on one of the convex ends 51 and from a side to the opposite side of the pivoting structure 5. The groove 52 has two ends, each of which comprises a contact surface 53.

The concaves 16 are adapted to receive the convex ends 51 respectively. Thus, the two convex ends 51 of the pivoting structure 5 can pivot on the concaves 16 of the bearing structure of the main body 1 so that the connector 3 connected with the pivoting structure 5 can rotate along the first axis A. The bearing structure further comprises a protruding column 17 formed on one of the concaves 16. The protruding column 17 can slide within the groove 52, while the pivoting structure 5 is capable of rotating along the second axis B that is perpendicular to the first axis A in this embodiment. Furthermore, the protruding column 17 is adapted to be in touch with the two contact surfaces 53 of the groove 52 so that the connector 3 is adapted to rotate within a rotation angle along the second axis B. More specifically, after the connector 3 is outwardly rotated from the second receiving space 15 to a terminal position along the shaft axis A, the connector 3 can subsequently rotate along the second axis B.

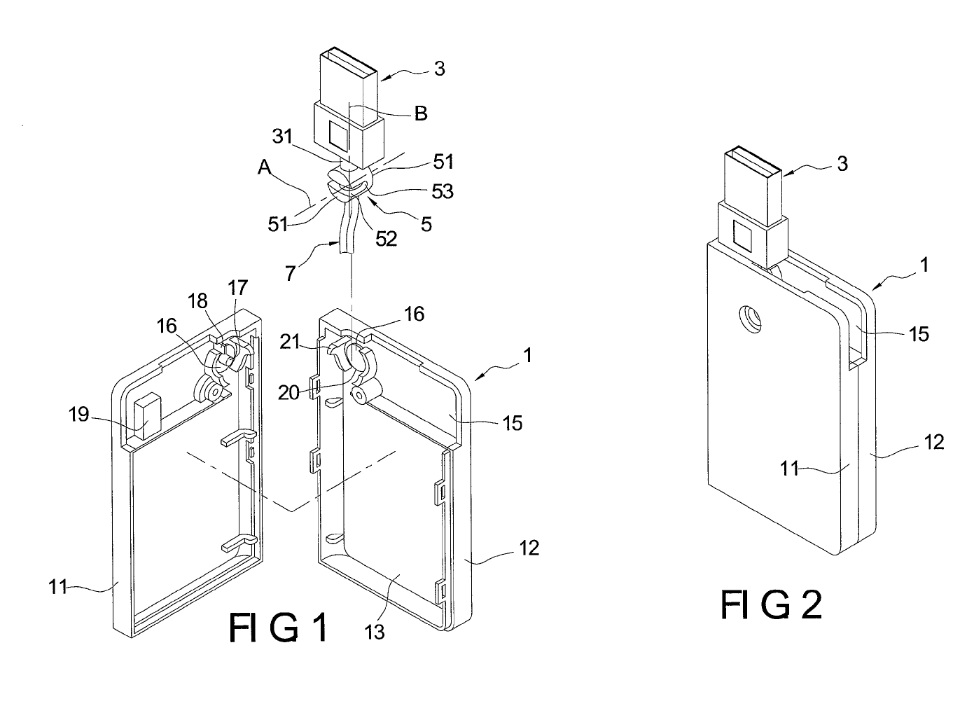

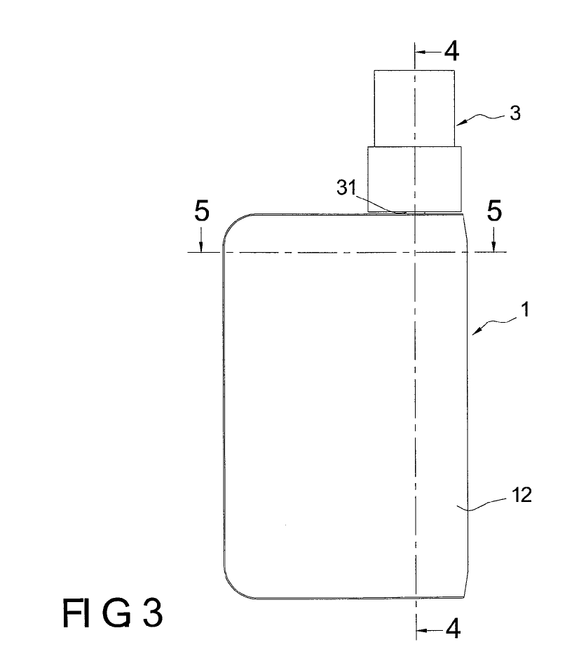

Because the connector 3 can rotate along the first axis A, the connector 3 can be accommodated in the second receiving space 15 when the connector is not being used (as shown in FIG. 7). Thus, the connector can be protected in the main body 1 and the dimensions of the electronic device can be reduced. When the user intends to use the connector 3, he or she may rotate the connector 3 along the shaft axis A to the outside of the second receiving space 15 (as shown in FIG. 2) to plug the connector into other electronic apparatuses.

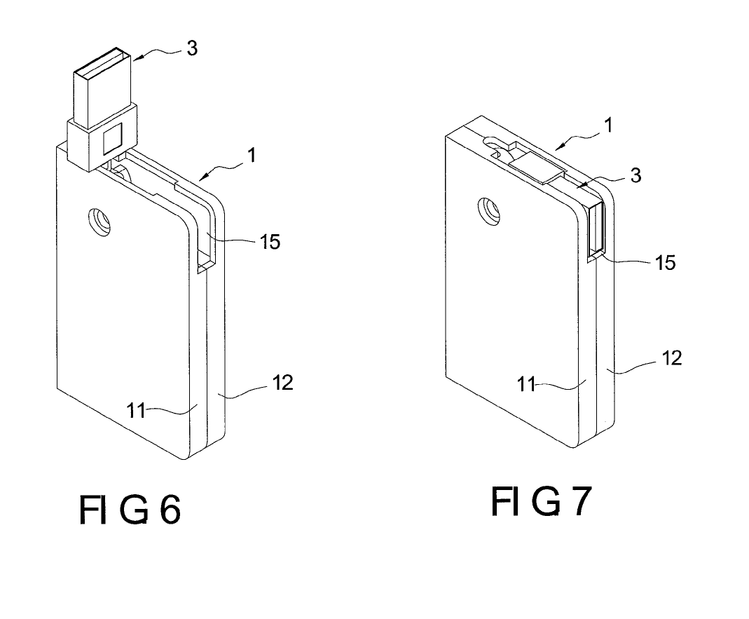

As shown in FIG. 6, after the connector 3 is rotated from the second receiving space 15 to the outside of the main body 1, the connector 3 can further rotate along the second axis B which is perpendicular to the first axis A, so that the angle between the connector 3 and the main body 1 can be adjusted. When the connector 3 rotates 90 degrees clockwise or counterclockwise along the second axis B, the protruding column 17 may come into contact with the contact surfaces 53 to limit the rotation of the connector 3.

After the connector 3 is rotated from the second receiving space 15 to the outside of the main body 1, the rod 31 of the connector 3 contacts and then surpasses the positioning plate 18 to stay in the terminal position on the other side of the positioning plate 18. Then, the positioning plate 18 is capable of abutting against the rod 31. By utilizing the positioning plate 18, the connector 3 is firmly positioned in an operating status.

When the connector 3 is not being used and is received in the second receiving space 15, the positioning block 19 contacts one side of the connector 3 to firmly position the connector 3 in the received status.

According to the aforesaid disclosures, the structure of the concaves 16 and the pivoting structure 5 are simplified to reduce the manufacturing costs. The dimension of the pivoting structure 5 is small, so that the electronic device can be slimmer and more lightweight.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic device with a multiple-direction rotation connector, comprising:
a main body having a bearing structure;
a pivoting structure pivoting on the bearing structure for being capable of rotating along each of a first axis and a second axis;
wherein the connector is fixed onto the pivoting structure.

2. The electronic device as claimed in claim 1, wherein the connector is a USB connector or an IEEE 1394 connector.

3. The electronic device as claimed in claim 2, wherein the pivoting structure comprises two convex ends, and the bearing structure comprises two opposite concaves being adapted to receive the convex ends respectively, whereby the pivoting structure is capable of rotating along the first axis when the convex ends rotate with respect to the concaves.

4. The electronic device as claimed in claim 3, wherein one of the convex ends is formed with a groove, and the bearing structure comprises a protruding column being formed on one of the concaves, whereby the pivoting structure is capable of rotating along the second axis when the protruding column slides within the groove.

5. The electronic device as claimed in claim 4, wherein the groove includes two ends, each of which has a contact surface being adapted to be in touch with the protruding column, whereby the connector is adapted to rotate within a rotation angle along the second axis.

6. The electronic device as claimed in claim 5, wherein the two ends of the groove are opposite with respect to the pivoting structure.

7. The electronic device as claimed in claim 3, wherein the bearing structure comprises a plurality of side partitions being disposed adjacent to the concaves for constraining the convex ends of the pivoting structure.

8. The electronic device as claimed in claim 2, wherein the connector comprises a rod disposed at an end portion thereof to be fixed onto the pivoting structure.

9. The electronic device as claimed in claim 8, wherein the main body comprises a positioning plate disposed adjacent to one of the concave of the bearing structure, whereby the positioning plate is capable of abutting against the rod when the connector outwardly rotates to a terminal position along the first axis.

10. The electronic device as claimed in claim 2, wherein the main body comprises a first shell and a second shell, being adapted to be assembled with each other to form a first receiving space and a second receiving space therein.

11. The electronic device as claimed in claim 10, further comprising an electronic element and a conductive wire, wherein the electronic element is disposed in the first receiving space, and the conductive wire electrically connects the connector with the electronic element.

12. The electronic device as claimed in claim 11, wherein the electronic element is a storage device.

13. The electronic device as claimed in claim 10, wherein the main body is formed with an opening to expose the second receiving space, whereby the connector is capable of passing through the opening and received in the second receiving space.

14. The electronic device as claimed in claim 13, wherein the main body further comprises a positioning block being adapted to contact with the connector when the connector is received in the second receiving space.

15. The electronic device as claimed in claim 2, wherein the electronic device is a portable drive, a wireless network receiver, or a wireless mouse receiver.
